(19) United States
(12) Patent Application Publication
(10) Pub. No.: US 2014/0072689 A1
(43) Pub. Date: Mar. 13, 2014

(54) Hot Beverage Maker

(71) Applicant: Sunbeam Products, Inc., Baca Raton, FL (US)

(72) Inventors: William Ho, Tamarac, FL (US); Dennis Leung, Chaiwan (HK)

(21) Appl. No.: 14/118,435

(22) PCT Filed: May 16, 2012
(86) PCT No.: PCT/US2012/038138

§ 371 Date: Nov. 18, 2013

Related U.S. Application Data
(60) Provisional application No. 61/486,591, filed on May 16, 2011.

(51) Int. Cl. A47J 31/44

(52) U.S. Cl. CPC A47J 31/4496
USPC 426/569; 99/323.3; 99/287

(57) ABSTRACT

A hot beverage maker is provided for making latte by frothing milk in a carafe before and/or while brewing coffee and directing the brewed coffee into the carafe for mixing with the frothed milk. An agitating element, extends downwardly from a frothing motor attached to the cover of a carafe into the carafe for frothing milk while coffee is being brewed in a brew head of the beverage maker. Brewed coffee is directed into the milk as it is being frothed and is mixed with the milk by the frothing elements to make latte. A lever assembly is selectively movable between an “On” and “Off” position. In the “On” position, terminal pins are moved into contact with terminal plates on the carafe cover to provide electricity to the frothing motor. In the ‘Off position, the terminal pins are moved away from contact with the terminal plates.

### FIELD OF THE INVENTION

The present invention relates to a hot beverage maker and, more particularly, to a latte maker that froths milk in the carafe while automatically brewing coffee and directing the brewed coffee into the carafe for mixing with the frothed milk.

### BACKGROUND OF THE INVENTION

Hot beverages such those made from coffee such as cappuccino, espresso and latte have become very popular. More recently, consumers have had a desire to eliminate the inconvenience of having to go to specialty coffee houses to buy these beverages and to make these hot beverages at home. Many of the current hot beverage makers of this type adapted for home use are large, expensive, difficult to clean, are not completely automatic and cannot make smaller, individual portions. As a result, there is a need for a low cost, fully automatic hot beverage maker of this type for use in the home that is easy to clean and can make small, individual portions of a brewed beverage.

### SUMMARY OF THE INVENTION

The present invention includes a hot beverage maker for making latte by frothing milk in the carafe before and/or while brewed coffee is directed into the carafe for mixing with the frothed milk. A mixing head in the cover of the carafe has rotating agitating elements that extend downwardly from the cover into the carafe for frothing milk while coffee is being brewed in a brew head of the beverage maker. Brewed coffee is directed into the milk as it is being frothed and is mixed with the milk by the frothing elements to make latte. Various embodiments of the beverage maker are contemplated including but not limited to those described in PCT Patent Application No. PCT/US10/59801 filed on Dec. 10, 2010, commonly owned by Jarden Consumer Solutions, which are incorporated by reference in its entirety as if fully rewritten herein.

One embodiment of the present hot beverage maker includes a main housing, a lower housing assembly and a brew head having a top housing, a basket assembly, and a top lid. A pitcher assembly is mountable in a recess formed by the main housing and the lower housing assembly. A lever assembly is fitted on the bottom of the top housing for controlling the operation of the brew head and a frothing unit disposed in the cover of the pitcher assembly.

In operation, milk is added to the pitcher assembly and the pitcher assembly is placed into the recess formed by the main housing and the lower housing assembly. A socket embedded in the lower housing assembly provides electrical power to a plug in the bottom of the pitcher assembly. The plug provides electrical power to a carafe heater in the bottom of the pitcher assembly for warming the milk to a temperature that is ideal for frothing the milk. In addition, terminals embedded in the cover engage electrical terminals embedded in a beverage spout to provide electrical power to a frothing motor. When energized, the frothing motor rotates a whisk or agitator element(s) that extend downwardly from the cover into the pitcher assembly.

The carafe heater and frothing motor are energized when the lever assembly is moved to a closed or depressed position. At the same time, a water heater assembly is energized to begin brewing coffee in the brew head. Water supplied from a reservoir in the main housing is heated and transferred via the water heater assembly by known means to a shower head into the basket assembly. The hot water is dripped over an infusible material such as ground coffee in the brew basket assembly to brew a hot beverage such as coffee. The brewed coffee is then directed through the bottom of the top housing into an opening in the cover of the pitcher assembly and into the pitcher assembly. The rotating whisk mixes the brewed coffee with the frothed milk to form a hot beverage such as a latte. The carafe heater, frothing motor, water heater assembly and an indicator light on the top housing of the brew head are de-energized when the temperature of the hot beverage reaches a pre-determined temperature as detected by a thermostat in the bottom of the pitcher assembly.

In order to serve the hot beverage, the lever assembly is moved to an open or released position and electrical power being supplied to the carafe heater, frothing motor and water heater assembly is interrupted if not previously de-energized by the thermostat in the bottom of the pitcher assembly when the pre-determined temperature of the hot beverage has been reached. The carafe heater, frothing motor, water heater assembly and indicator light are disabled after being de-energized by the thermostat in the bottom of the pitcher assembly until the lever assembly is moved to an open or released position and then back to the closed or depressed position.

Alternately, a switch mounted on the top housing can be moved to disconnect electrical power to the water heater assembly. In this manner, a hot beverage such as cocoa can be made from the frothed milk by adding cocoa powder to the milk prior to replacing the pitcher assembly in the main housing. When the lever assembly is depressed, only the carafe heater and frothing motor are energized since powder was interrupted to the water heater assembly. The heated, frothed milk is mixed with the cocoa powder to make hot cocoa which may be served when the lever assembly is returned to the open or released position.

As will be understood, other mechanisms may be used to interrupt the flow of electricity to one or more components of the hot beverage maker to effectively disable that one or more components. For example, a timer may be present which disables power to various components after a certain period of time. A water level detector may detect when the reservoir is empty and disable the flow of electricity to the water heater assembly. A thermometer associated with the water heater assembly may detect the temperature of the water in the water heater assembly, and cycle the flow of electricity to the water heater assembly heater off when a pre-determined temperature of the water has been reached in the water heater assembly and then on when the temperature of the water falls below a pre-determined temperature.

### DESCRIPTION OF THE DRAWINGS

FIG. 1 is a perspective view of one embodiment of a hot beverage maker constructed according to the teachings of the present invention.

FIG. 2 is an exploded perspective view of the hot beverage maker of FIG. 1.

FIG. 3 is an exploded perspective view of one embodiment of the pitcher assembly constructed according to the teachings of the present invention.

FIG. 4 is an exploded view of one embodiment of the lever assembly constructed according to the teachings of the present invention.

FIG. 5A is a perspective view of the lever assembly of FIG. 4 in its assembled condition and in an “Off” state.

FIG. 5B is a bottom perspective view of the lever assembly of FIG. 5A in an “Off” state.

FIG. 6A is a cross-sectional view of the lever assembly of FIG. 5A in an “Off” state.

FIG. 6B is a cross-sectional view of the lever assembly of FIG. 5A in an “On” state.

FIG. 7A is a cross-sectional view of the lever assembly of FIG. 4 in an “Off” state as in conjunction with a brew basket assembly constructed according to the teachings of the present invention.

FIG. 7B is a cross-sectional view of the lever assembly of FIG. 4 in an “On” state as in conjunction with a brew basket assembly constructed according to the teachings of the present invention.

It should be understood that the present drawings are not necessarily to scale and that the embodiments disclosed herein are sometimes illustrated by fragmentary views. In certain instances, details which are not necessary for an understanding of the present invention or which render other details difficult to perceive may have been omitted. It should also be understood that the invention is not necessarily limited to the particular embodiments illustrated herein. Like numbers utilized throughout the various figures designate like or similar parts or structure.

### DETAILED DESCRIPTION

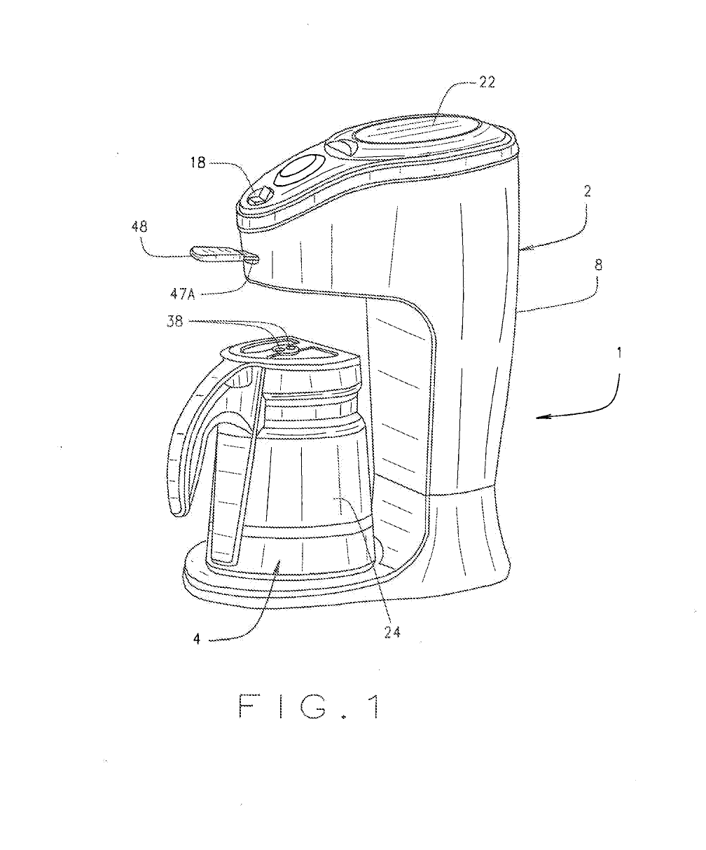

Referring now to the drawings and, more particularly, to FIG. 1, a hot beverage maker 1 constructed according to the teachings of one embodiment of the present invention is shown including a base unit 2 and a pitcher assembly 4. The pitcher assembly 4 fits into a recess in the base unit 2 so as to allow coffee brewed in the base unit 2 to drip into the pitcher assembly 4.

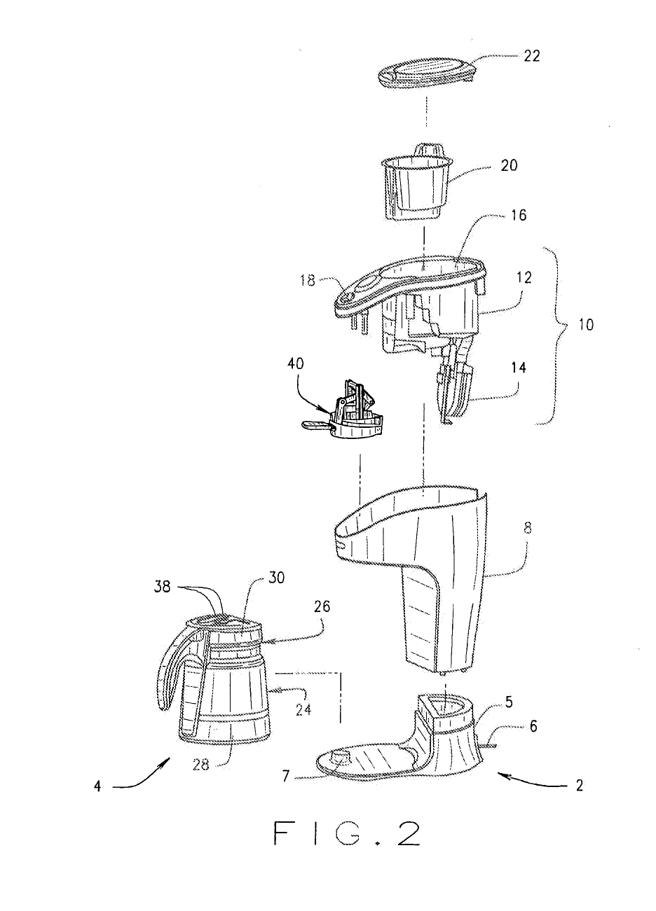

As can be seen in FIG. 2, base unit 2 includes a lower housing assembly 5. Lower housing assembly 5 includes an electrical cord 6 and plug 7. Electrical cord 6 is preferably designed to plug into a standard household 110V electrical outlet so as to supply the hot beverage maker 1 with power. However, as will be understood by one of ordinary skill in the art, the electrical cord 6 may be designed for electrical outlets of other shapes, types, voltages, and so forth, as may be the norm in other countries. Plug 7 extends upwardly from the lower housing assembly and is positioned to electrically connect to pitcher assembly 4 when pitcher assembly 4 is placed into the recess in base unit 2 for making a hot beverage. Plug 7 supplies at least a portion of the electricity used by the pitcher assembly 4.

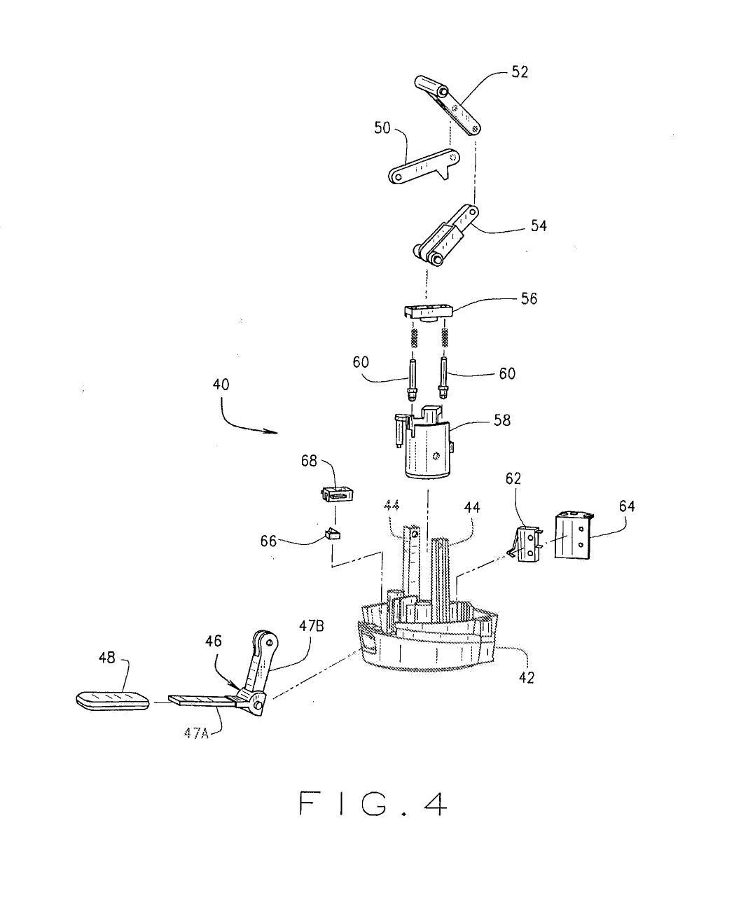

Base unit 2 also includes main housing 8 which is positioned above and is connected to lower housing assembly 5. Brew head assembly 10 resides substantially within main housing 8, and includes a top housing 12, water heater assembly 14, reservoir 16, mode selection switch 18 and a power indicator light (not shown). A brew basket assembly 20 is generally positioned within top housing 12, but is preferably removable therefrom. Reservoir 16 is preferably separated from brew basket assembly 20 such that liquid in reservoir 16 is not in direct contact with brew basket assembly 20. Reservoir 16 may be shaped and contoured to at least partially surround brew basket assembly 20. A lever assembly 40 is also associated with the top housing 12 and positioned within the main housing 8 as will be discussed in detail in connection with FIGS. 4-6. Top lid 22 covers the reservoir 16 and brew basket assembly 20.

As will be understood, when coffee is to be brewed, coffee grounds are loaded into the brew basket assembly 20, which is then inserted into brew head 10. Once water is poured into reservoir 16 and the brew cycle is activated, water is drawn from reservoir 16 into water heater assembly 14 where it is heated. The water then travels from water heater assembly 14 through a showerhead (not shown) that directs the heated water into the coffee grounds contained within the brew basket assembly 20. Water heater assembly 14 may include a fluid pump to pump liquid from the reservoir 16 to be heated, and to pump the heated water through the shower head into brew basket assembly 20. Alternatively, such a fluid pump or other mechanism to pump liquid may be separate from water heater assembly 14. As an additional alternative, no fluid pump may be used and the water heater assembly 14 pumps the water through the shower head into the brew basket assembly 20 by pressurizing the water by heating. The hot water seeps through the coffee grounds, and drips from the brew head 10 as brewed coffee, down into the pitcher assembly 4 for holding and storage therewithin.

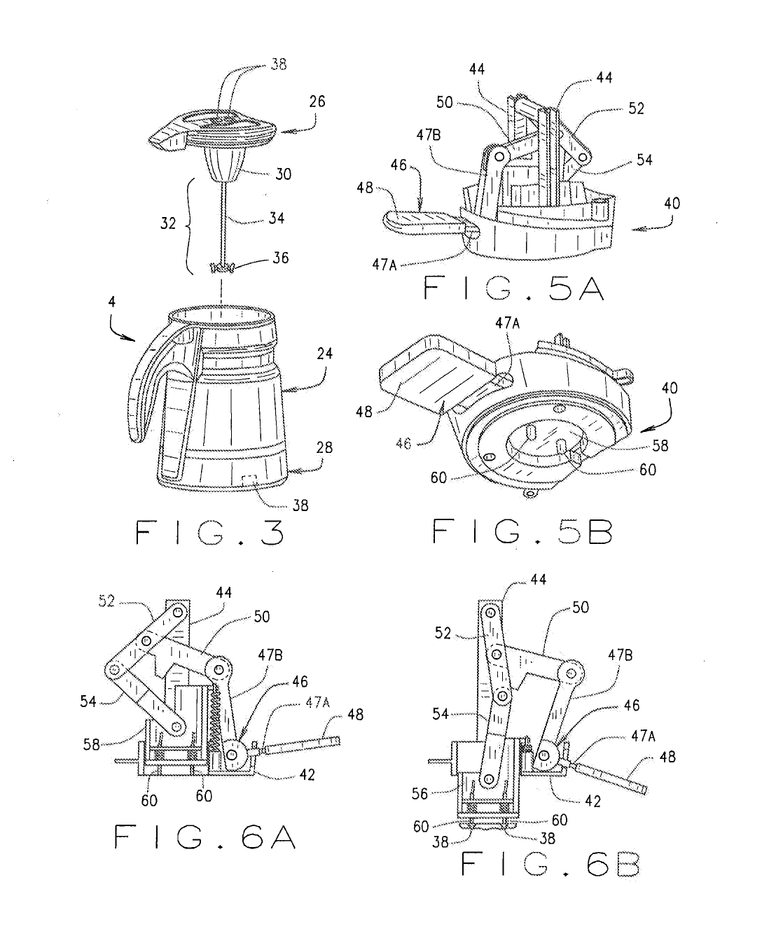

FIG. 3 illustrates pitcher assembly 4 in additional detail. Pitcher assembly 4 includes carafe 24, which may be made of glass, ceramic material, metal, or another suitable material. Carafe 24 may include side walls and a bottom portion to retain liquids therein, or may merely include side walls such that carafe heater 28 forms the bottom thereof to retain liquids therein. Carafe 24 also includes carafe heater 28, which may be located within carafe 24 or may be connected to the bottom of carafe 24. Other suitable arrangements and locations for carafe heater 28 are also envision, such as in the lower housing assembly 5. However, such a location for the carafe heater 28 would allow it to heat the contents of the carafe 24 only when the carafe 24 is fitted into the base unit. Preferably, pitcher assembly 4 includes a socket 38 configured to receive plug 7 of the lower housing assembly 5 when the pitcher assembly 4 is fitted into the base unit. Plug 7 thereby provides electrical, power to the carafe heater 28 through socket 38. Pitcher assembly 4 may also include batteries, such as rechargeable batteries (not shown) to allow the carafe heater 28 to continue heating the contents of the carafe 24 even when the carafe 24 is removed from the lower housing assembly 5.

Cover 26 rests on top of carafe 24 and may be connectable thereto. Cover 26 includes a frothing motor 30, which is mechanically connected to an agitator element 32. Agitator element 32 may include a shaft 34 which extends down into carafe 24 when the cover 26 is placed thereon. Agitator element 34 may also include a whisk 36, which may be located at a distal end of the shaft 34. Preferably, when the cover 26 placed on the carafe 24, the shaft 34 extends downwardly therein to position the whisk 36 in a liquid contained in the carafe 24. When frothing motor 30 is engaged, it turns whisk 36 via shaft 34 to agitate the liquid in the carafe 24 thereby frothing the liquid. Electrical power is supplied to frothing motor 30 via terminal plates 38 which are located on the top of cover 26.

FIGS. 4, 5A, 5B, 6A and 6B all illustrate one embodiment of the lever assembly 40. FIG. 4 illustrates an exploded view of a lever assembly 40 according to one embodiment of the present invention, while FIGS. 5A and 5B show the assembled lever assembly 40 in an “Off” state, from a top perspective and a bottom perspective view, respectively. FIG. 6A illustrates a cross-sectional view of lever assembly 40 in an “Off” state, while FIG. 6B illustrates a cross-sectional view of lever assembly 40 in an “On” state.

As can be best seen in FIG. 4, lever assembly 40 includes a base 42, vertical posts 44, lever handle 46, lever handle cover 48, horizontal lever 50, top lever 52, lower lever 54, terminal press plate 56, terminal mount 58, terminal pins 60, micro switch 62, micro switch mount 64, detent 66 and detent cover 68. Terminal pins 60 extend through the bottom of terminal mount 58. Terminal mount 58 and terminal pins 60 are selectively movable through a through-hole in base 42.

Base 42 serves as a base for the lever assembly 40 and may include vertical posts 44 which serve as support structures for the lever mechanism. Lever handle 46 is preferably an angled lever, with a first arm 47A and a second arm 47B connected at a vertex. The first arm 47A extends through a through-hole in base 42. A lever handle cover 48 may cover the first arm 47A.

As can best be seen in FIGS. 6A and 6B, second arm 47B of lever handle 46 extends generally upwardly from the vertex and hingedly connects with one end of horizontal lever 50. Horizontal lever 50 extends from second arm 47B and hingedly connects to top lever 52. The top end of top lever 52 is hingedly connected to vertical posts 44, while the bottom end of top lever 52 is hingedly connected to the top end of lower lever 54. The bottom end of lower lever 54 is hingedly connected to terminal mount 58, or to a terminal press plate 56 which is in turn connected to terminal mount 58.

In operation, and as shown in FIGS. 5A, 5B and 6A, when lever assembly 40 is in its “Off” state, the terminal mount 58 and terminal pins 60 are positioned so as to be withdrawn up into lever assembly 40. The first arm 47A of lever handle 46 is positioned slightly above horizontal such that the second arm 47B of lever handle 46 is angled slightly rearward of vertical. This positioning of second arm 47B pushes horizontal lever 50 rearward, where it in turn pushes top lever 52 away from vertical, lifting the bottom of top lever 52 upwardly to a raised position. Top lever 52 pulls lower lever 54 upwardly as well, and lower lever 54 thereby pulls terminal mount 58 upwardly.

However, as shown in FIG. 6B, when the first arm 47A of lever handle 46 is positioned slightly below horizontal, such movement forces the second arm 47B of lever handle 46 to be angled slightly forward of vertical. This positioning of second arm 47B pulls the horizontal lever 50 forward as well, and horizontal lever 50 in tarn pulls top lever 52 forward toward vertical such that the bottom of top lever 52 is pushed downwardly. Top lever 52 pushes lower lever 54 downwardly and toward a vertical position as well, and lower lever 54 thereby pushes terminal mount 58 (and terminal pins 60) downwardly to a lowered position such that the terminal pins 60 extend from the bottom of base 42 as shown in FIG. 6B.

Preferably, lever assembly 40 is biased toward its “Off” position. Such a biasing effect may be produced by springs or other biasing mechanism which predisposes the terminal mount 58 toward its raised position. When the lever assembly 40 is acted upon and placed in its “On” position as shown in FIG. 6B, a ball detent 66 and detent cover 68 may be utilize to retain the lever assembly 40 in place. When placed into its “On” position, detent 66 may engage with another component of lever assembly 40, as would be understood by one of ordinary skill in the art. A detent 66 and detent cover 68 may also be used to retain the lever assembly 40 in its “Off” state, but such additional detent may be unnecessary where a biasing mechanism is already in use to bias the lever assembly 40 toward its “Off” state as discussed above.

As shown, horizontal lever 50 connects with top lever 52 toward the middle of top lever 52. As will be understood, horizontal lever 50 may connect to top lever 52 at a different location, or may be connected to lower lever 54. The structure and positioning of the various components in lever assembly 40 is dependent on the size, shape and location of the specific components. As would be understood, other constructions could be used in order to raise and lower the terminal mount 58 and terminal pins 60. Alternatively, lever assembly 40 may be electrically operated rather than mechanically operated as disclosed herein.

By putting the lever assembly 40 into the “On” state, the terminal mount 58 and terminal pins 60 extend downwardly from the bottom of the base 42 and lever assembly 40 as a whole. When the pitcher assembly 4 is placed into its recess in the base unit 2, the terminal plates 38 on the top of the cover 26 and the terminal pins 60 are positioned such that the terminal pins 60 electrically engage the terminal plates 38 when the lever assembly 40 is placed into its “On” position. Effectively, putting the lever assembly 40 into its “On” position causes the terminal mount 58 and terminal pins 60 to extend downwardly toward the pitcher assembly 4 such that the terminal pins 60 electrically engage the terminal plates 38 on the cover 26. In so doing, electrical power may be supplied by the terminal pins 60 to the frothing motor 30 via terminal plates 38. Electrical wires (not shown) may connect terminal plates 38 to the frothing motor 30, and may connect terminal pins 60 to a source of electricity, as would be understood by one of ordinary skill in the art.

Lever assembly 40 may also include a micro switch 62 and a micro switch mount 64 for connecting the micro switch 62 to the base 42 or other component of the lever assembly 40. In one embodiment, placing the lever assembly 40 in its “On” or “Off” state may toggle micro switch 62. Preferably, placing lever assembly 40 into its “Off” state toggles micro switch 62 into its “Off” state, thereby breaking any the electrical current which could flow through micro switch 62. Placing lever assembly 40 into its “On” state preferably toggles micro switch 62 into its “On” state allowing electrical current to flow therethrough. As shown in FIG. 4, micro switch 62 is preferably a “Normally Open” switch which is biased toward its “Off” state when not otherwise acted upon (such as when lever assembly 40 is in its “Off” state). However, when lever assembly 40 is placed in its “On” state, the physical movement of the components of the lever assembly acts upon micro switch 62 to close the switch and allow electricity to flow therethrough. Alternatively, micro switch 62 may be electronically controlled based on the state of the lever assembly 40 or based on other input from a user.

When lever assembly 40 is in its “Off” position, no electricity can flow through the micro switch 62 which de-energizes a relay (not shown) cutting electrical power off to the entire hot beverage maker 1. However, when lever assembly 40 is in its “On” position, electricity can flow through micro switch 62 which energizes the relay and power is supplied to all of the components in hot beverage maker 1 (unless the power is otherwise restricted from getting to a specific component). Thus, micro switch 62 through the relay and lever assembly 40 as a whole, may effectively be the on/off switch for the entire hot beverage maker 1. Moving the lever assembly 40 into its “Off” position turns off the machine by cutting power to all components. Moving the lever assembly 40 into its “On” position turns the machine on by allowing power to reach various components, and by physically providing the electrical contact between the terminal pins 60 and the terminal plates 38.

Selection switch 18, shown in FIG. 2 on top housing 12, is also preferably integrated into the electrical system of hot beverage maker 1. Selection switch 18 controls the flow of electricity to the coffee brewing components of hot beverage maker 1, including water heater assembly 14 and any necessary fluid pumps as would be understood by one of ordinary skill in the art. By placing selection switch 18 into its “On” or “Coffee” mode, hot beverage maker 1 brews coffee when lever assembly 40 is placed in its “On” position. However, by placing selection switch 18 into its “Off” mode, hot beverage maker 1 does not brew coffee when lever assembly 40 is placed into its “On” position. Instead, electricity is delivered to frothing motor 30 to cause agitator element 32 to whisk the contents of carafe 24. Similarly, electricity is delivered to carafe heater 28 through socket 38 to heat the contents of carafe 24.

Thus, when a user wishes to make a cafe latte beverage, the user places milk into the carafe 24, and then pours water into reservoir 16 and places coffee grounds into brew basket assembly 20. The user then places selection switch 18 in its “On” position, and engages lever assembly 40 to place it into its “On” position. Micro switch 62 is thereby engaged which energizes the relay (not shown), allowing electricity to flow to carafe heater 28 through socket 38 to heat the milk in carafe 24. Simultaneously, electricity flows through terminal pins 60 to terminal plates 38, and then to frothing motor 30 which froths the milk in carafe 24 with agitator element 32 as the milk is being heated. Additionally, since selection switch 18 is in its “On” position, electricity flows via the relay controlled by the micro switch 62, through selection switch 18, to water heater assembly 14 and to any other electrically powered coffee brewing components. Coffee is therefore brewed, and dripped from brew head assembly 10 into carafe 24 to be mixed into the frothed and heated milk by agitator element 32. In this way, a cafélatte may be created. The carafe heater 28, frothing motor 30, water heater assembly 14 and an indicator light (not shown) on the top housing of the brew head are de-energized when the temperature of the hot beverage reaches a pre-determined temperature as detected by a thermostat (not shown) in the bottom of the pitcher assembly 4.

Alternatively, a user may wish to make a heated and mixed beverage without the inclusion of coffee therein. In that situation, the user would place milk into the carafe 24, and, in the case of hot chocolate, pour hot chocolate mix or other ingredients into the milk in carafe 24. Before engaging lever assembly 40, the user places selection switch 18 into its “Off” position. When lever assembly 40 is engaged, micro switch 62 is thereby engaged energizing the relay and allows electricity to flow to carafe heater 28 through socket 38 to heat the milk in carafe 24. Simultaneously, electricity flows through terminal pins 60 to terminal plates 38, and then to frothing motor 30 which froths the milk and other ingredients in carafe 24 with agitator element 32 as the mixture is heated. However, since selection switch 18 is in its “Off” position, no electricity flows to water heater assembly 14 or to any other electrically powered coffee brewing components. Thus, no coffee is brewed, and solely the mixture in the carafe 24 is heated and mixed, so as to be served as a hot beverage.

As noted above, the structure and positioning of the various components in lever assembly 40 is dependent on the size, shape and location of the specific components. As would be understood, other constructions could be used in order to raise and lower the terminal mount 58 and terminal pins 60. Lever assembly 40 may alternatively be electrically operated rather than mechanically operated as disclosed herein, such that terminal pins 60 are raised and lowered via an electric motor. In this regard, the lever assembly 40 may alternatively include a button rather than a lever handle 46. Lever assembly 40, frothing motor 30 and agitator element 32 may also be located at the bottom of carafe 24 rather than as part of cover 26. In such a construction, terminal plates 38 in cover 26 may be electrically connected via wiring and associated conductive hardware (as would be understood by one of ordinary skill in the art) to frothing motor 30 in carafe 24. Alternatively, power may be supplied to frothing motor 30 in carafe 24 via socket 38, in which case a mechanically actuated lever assembly 40 with terminal pins 60 may be unnecessary.

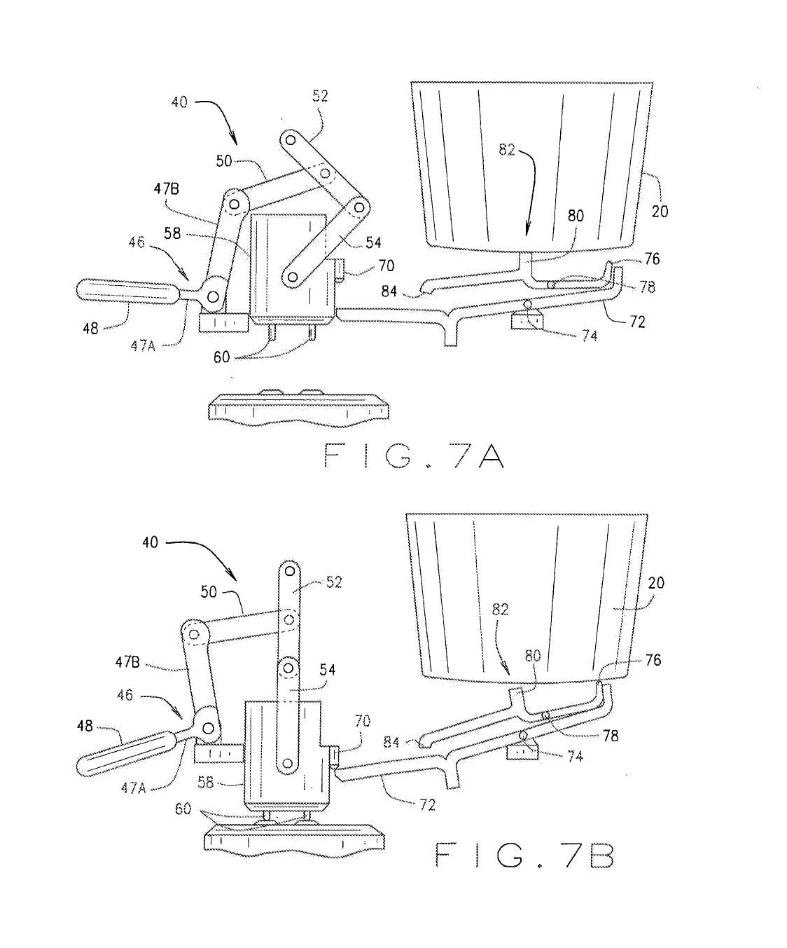

As shown in FIGS. 7A and 7B, lever assembly 40 may interact with brew basket assembly 20. In one embodiment, lever assembly 40 includes a flange 70 which moves up and down in conjunction with terminal mount 58. Brew basket assembly 20 may include a first lever 72 which pivots about member 74, and a second lever member 76 that pivots about member 78. The second lever member may include a stopper 80 which selectively engages with a hole 82 in the bottom of brew basket assembly 20. When stopper 80 is engaged with the hole 82 in brew basket assembly 20, liquid is prevented from flowing through hole 82, as shown in FIG. 7A when lever assembly 40 is in its “Off” position.

However, as shown in FIG. 7B, when lever assembly 40 is placed in its “On” position, flange 70 moves down and presses on one end of lever 72, causing lever 72 to pivot about member 74. The other end of lever 72 therefore moves up, pushing upwardly against one end of second lever 76. This upward action of one end of second lever 76 causes second lever 76 to pivot about member 78 such that the other end of second lever 76 moves downwardly. The downward movement the other end of second lever 76 moves stopper 80 out of engagement with hole 82 in brew basket assembly 20 such that liquid can flow through hole 82.

In one embodiment, the other end of second lever 76 includes a spout 84, and liquid leaving brew basket assembly 20 through hole 82 drips into a channel on second lever 76 and flows down to and out of spout 84. Liquid may thereafter flow down into pitcher assembly 4.

When lever assembly 40 is placed back into its “Off” position, flange 70 no longer acts upon lever 72, such that lever 72 no longer acts upon second lever 76. Thus, stopper 80 on second lever 76 moves back into engagement with hole 82 on brew basket assembly 20 to prevent the further flow of liquid through hole 82. This effectively stops further liquid from flowing down into pitcher assembly 4 from base unit 2.

As will be understood, the structure disclosed for brew basket assembly 20 may differ depending on the size, shape and location of the brew basket assembly 20 and the structure of lever assembly 40. A single lever may be used in brew basket assembly 20 rather than both levers 72 and 76 as disclosed above. Similarly, actuation of such a lever may be electromechanical, rather than mechanical as described above, such as where the lever assembly 40 is replaced with an electronic interface.

Thus, there has been shown and described several embodiments of a novel hot beverage maker. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present invention will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A hot beverage maker comprising:
a base unit including a lever assembly, said lever assembly including movable terminal pins; and
a pitcher assembly including:
a carafe;
a cover having terminal plates connected to a frothing motor, said frothing motor being adapted to move an agitator element, said agitator element residing within said carafe when the cover is placed on the carafe;
said lever assembly being selectively movable between an “On” and “Off” position, wherein in the “On” position the terminal pins of the lever assembly are moved into engagement with the terminal plates of the cover to provide electrical power therethrough to the frothing motor, and wherein in the “Off” position the terminal pins of the lever assembly are moved away from engagement with the terminal plates of the cover to discontinue the flow of electricity therethrough.

2. The hot beverage maker of claim 1 wherein:
the pitcher assembly further includes a heater and a socket adapted for providing electrical power to the heater;
the base unit further includes a plug adapted for engagement with the socket to provide electrical power therethrough; and
said heater being engaged to heat the contents of said carafe via power received through said socket from said plug when the lever assembly is placed in the “On” position.

3. The hot beverage maker of claim 1 wherein the base unit further includes:
a brew basket assembly for containing coffee grounds;
a reservoir for holding water; and
a water heater assembly for heating the water and directing the heated water through the coffee grounds to brew coffee;
wherein placing the lever assembly in the “On” position also engages the water heater assembly to brew coffee, said brewed coffee being directed into the carafe.

4. The hot beverage maker of claim 3 wherein the base unit further includes a selection switch having “On” and “Off” settings, wherein selecting the “Off” setting for the selection switch is operable to stop the flow of electricity to the water heater assembly even when the lever assembly is engaged in its “On” position.

5. The hot beverage maker of claim 1 wherein the lever assembly includes a micro switch for controlling the flow of electrical power to at least one electrical component within the hot beverage maker, and wherein placing the lever assembly in the “Off” position also causes the micro switch to stop the flow of electricity to the at least one electrical component of the hot beverage maker.

6. A method of making a hot beverage including:
heating and frothing a liquid in a pitcher assembly of a hot beverage maker;
brewing coffee in a base unit of the hot beverage maker, said brewing step occurring substantially simultaneously with said heating and frothing step; and
allowing the brewed coffee to flow into the pitcher assembly from the base unit for mixing with the liquid, and heating and frothing thereof to for the hot beverage.

7. The method of claim 6, further including the step of:
terminating the heating of the hot beverage in the container when a pre-determined temperature has been reached.

8. The method of claim 6, further including the step of:
terminating the frothing of the hot beverage when the pre-determined temperature has been reached.

9. The method of claim 6, further including the step of:
depressing a lever to initiate brewing the coffee into the pitcher assembly and initiate heating and frothing of the liquid in the pitcher assembly.
